(19) United States
(12) Patent Application Publication
(10) Pub. No.: US 2022/0074354 A1
(43) Pub. Date: Mar. 10, 2022

(54) TURBOGENERATOR METHOD AND APPARATUS

(71) Applicant: Bowman Power Group Limited, Southampton (GB)

(72) Inventor: Keith John Douglas, Southampton (GB)

(21) Appl. No.: 17/299,251

(22) PCT Filed: Dec. 19, 2019
(86) PCT No.: PCT/GB2019/053617

§ 371 Date: Jun. 2, 2021

(30) Foreign Application Priority Data
Dec. 20, 2018 (GB) 1820799.3

(51) Int. Cl. F02C 9/16

(52) U.S. Cl. CPC F02C 9/16; F05D 2270/301; F05D 2220/40

(57) ABSTRACT

A method for maximising the total power output of a power generation system is described the method comprising providing a power generation system comprising a turbocharged prime mover and a turbogenerator system driven by a flow of exhaust fluid from the prime mover, the turbogenerator system creating a backpressure on the turbocharged prime mover, comparing a parameter of the power generation system to a threshold value of the parameter, and adjusting the turbogenerator system to vary the backpressure on the turbocharged prime mover to change the parameter to become closer to the threshold value and increase the total power output or fuel efficiency of the power generation system. An apparatus for performing the method is also described.

This application is a national stage application under 35 U.S.C. § 371 of PCT Application No. PCT/GB2019/053617, filed Dec. 19, 2019, which claims the benefit of Great Britain Application No. 1820799.3, filed Dec. 20, 2018. The entire contents of each of PCT Application No. PCT/GB2019/053617 and Great Britain Application No. 1820799.3 are incorporated herein by reference in their entireties.

### TECHNICAL FIELD

The present disclosure relates to a method for maximising the total power output or improving the fuel efficiency of a power generation system, and more particularly to a method for maximising the total power output or improving the fuel efficiency of a power generation system comprising a turbogenerator.

### BACKGROUND

Turbogenerators are often incorporated within the exhaust of power generation systems to recover energy from the flow of exhaust fluids. One example of such a system is the incorporation of a turbogenerator within the exhaust of a prime mover such as an internal combustion engine.

In addition to a turbogenerator, power generation systems incorporating a prime mover such as an internal combustion engine may also include turbochargers to improve their performance and fuel efficiency. In systems of this nature, the turbocharger is used to increase the performance of the engine whilst the turbogenerator is fitted downstream of the turbocharger. In this location, the turbogenerator uses the flow of exhaust fluids to generate electrical power. As the turbogenerator provides a barrier to the flow of exhaust fluids through the exhaust conduit, it increases the backpressure on the turbocharger. This additional backpressure can result in a drop in the fuel efficiency or power output on the prime mover, as increased backpressure results in a reduction in the pressure differential across the turbocharger and reduces the mass of air supplied to the prime mover.

The additional backpressure created by the inclusion of a turbogenerator into a power generation system is frequently overcome by resizing the turbocharger such that the prime mover within the power generation system can accommodate the same load as the individual prime mover under all operating conditions. To ensure the prime mover within the power generation system is capable of providing the required power under any conditions, the turbocharger and turbogenerator are sized to ensure the prime mover can accommodate the maximum required load at extreme operating conditions. Typically, these extreme operating conditions include unfavourable ambient temperatures, ambient pressures (altitudes), humidity and engine ageing effects. When the power generation system is optimised in such a manner, under normal operating conditions there is further potential to increase the total power out or fuel efficiency of the power generation system. However, these additional reserves are left untapped by the systems of the prior art. Objects and aspects of the present disclosure seek to alleviate at least these problems.

### SUMMARY

According to a first aspect of the present disclosure there is provided a method for maximising the total power output of a power generation system, the method comprising; providing a power generation system comprising a turbocharged prime mover and a turbogenerator system driven by a flow of exhaust fluid from the turbocharged prime mover, the turbogenerator system creating a backpressure on the turbocharged prime mover, comparing a parameter of the power generation system to a threshold value of the parameter, and adjusting the turbogenerator system to vary the backpressure on the turbocharged prime mover to change the parameter to become closer to the threshold value and increase the total power output or fuel efficiency of the power generation system.

The method adjusts the mass of air that flows through the turbogenerator system or nozzle area at the inlet of the turbogenerator in response to a parameter of the power generation system to increase the total power output generated by the power generation system. The skilled addressee would understand that a parameter of the power generation system includes a state, a variable, a condition, an observation, a measurement, a value of the system, a value derived from any of the above as well as a condition of the system's environment.

The parameter preferably acts as a proxy value for the load or power output, or represents the power reserve designed into the turbocharging system or a value representing a mechanical or thermal limitation of the prime mover. The adjustment of the turbogenerator system is performed in response to the parameter. In this way, the turbogenerator system can be adjusted to keep the parameter close to a threshold value, such that the power output of the power generation system is always maximised. With such a method, the turbogenerator system is adjusted to maximise power generation and electrical efficiency whilst the backpressure placed by the turbogenerator on the turbocharged prime mover is managed to ensure the power generation system remains able to accommodate the required load within its mechanical and thermal limits.

Preferably, the step of providing a turbogenerator system further comprises the step of providing a turbogenerator bypass valve between the turbocharged prime mover and the turbogenerator within the flow of exhaust fluid, the turbogenerator bypass valve able to move between a bypass open position and a bypass closed position to alter the volume of exhaust fluid passing through the turbogenerator, and further wherein the step of adjusting the turbogenerator system to vary the backpressure on the turbocharged prime mover comprises moving the bypass valve between the bypass open position and the bypass closed position. Preferably, the bypass valve is arranged to receive exhaust flow from between the turbocharged prime mover and the turbogenerator, and is further arranged to return the exhaust flow to the turbogenerator system downstream of the turbogenerator. As such, the turbogenerator bypass valve can be used to control the power output, power reserve or fuel efficiency of the power generation system by affecting the air mass supplied by the turbocharger to the prime mover by virtue of controlling the backpressure on the prime mover.

Preferably, the step of moving the bypass valve between the bypass open position and the bypass closed position comprises moving the bypass valve towards the bypass closed position to increase the volume of exhaust fluid passing through the turbogenerator. Preferably, the step of moving the bypass valve between the bypass open position and the bypass closed position comprises moving the bypass valve towards the bypass open position to decrease the volume of exhaust fluid passing through the turbogenerator. In this configuration the turbogenerator bypass valve is used to bypass the turbogenerator and vent exhaust fluid flow to downstream of the turbogenerator. As such, moving the turbogenerator bypass valve towards the bypass open position reduces the backpressure on the turbocharger, and moving the turbogenerator bypass valve towards the bypass closed position increases the backpressure on the turbocharger.

Preferably, the step of providing a turbogenerator system further comprises the step of providing a turbogenerator comprising a variable geometry turbine, wherein the step of adjusting the turbogenerator system to vary the backpressure on the turbocharged prime mover comprises changing the geometry of the variable geometry turbine.

Preferably, changing the geometry of the variable geometry turbine comprises changing the effective aspect ratio of the variable geometry turbine effectively adjusting the area of the inlet to the turbine wheel and therefore varying the backpressure on the turbocharged prime mover. Preferably, changing the geometry of the variable geometry turbine comprises changing the inlet effective flow area of the variable geometry turbine.

Preferably, changing the effective aspect ratio of the variable geometry turbine comprises moving a plurality of vanes within the housing of the variable geometry turbine. Preferably, changing the effective geometry of the variable geometry turbine comprises utilising a sliding shroud to alter the flow area to the vanes or to the vanes of the variable geometry turbocharger. Preferably, changing the effective aspect ratio of the variable geometry turbine comprises any method which would be within the common general knowledge of the person skilled in the art.

Preferably, the parameter of the power generation system is a predetermined reference value of the parameter. Preferably, the step of comparing a parameter of the power generation system to the threshold parameter value involves calculating the relative difference or error between the parameter and the reference value. Preferably, the step of comparing a parameter of the power generation system to a threshold parameter value further comprises the step of calculating the rate of change of the parameter.

Preferably, the parameter of the power generation system is a parameter of the turbocharged prime mover. Preferably, the parameter is the power output generated by the prime mover. Preferably, the parameter is the peak firing pressure inside a cylinder of the prime mover.

Preferably, the parameter of the power generation system is a rate of fluid flow through the system. Preferably, the fluid is air. Alternatively, the fluid is exhaust fluid. Preferably, the rate of fluid flow is measured in a bypass to a part of the power generation system. Preferably, the rate of fluid flow is measured in a part of the power generation system.

Preferably, the parameter relates to fuel injection into the turbocharger prime mover. Preferably, the parameter is the air-fuel ratio. Preferably, the parameter is the fuel flow. Preferably, the parameter is the injection duration. Preferably, the parameter is the amount of fuel injected.

Preferably, the parameter of the turbocharged prime mover is the heat rejection of the turbocharged prime mover. Preferably, the heat rejection is determined by the temperature of an engine coolant at its outlet. Preferably, the heat rejection of the prime mover is determined by the difference in temperature of an engine coolant between its outlet and inlet. Preferably, the heat rejection of the prime mover is determined by the energy rejected.

Preferably, the parameter of the turbocharged prime mover is the speed of a turbine of the turbocharger.

Preferably, the method comprises the step of providing a valve in the power generation system. Preferably, the parameter of the power generation system is a parameter of the valve in the power generation system. Preferably, the parameter is the position of the valve. Preferably, the parameter is angle of the valve. Preferably, the parameter is the rate of flow of fluid through the valve. Preferably, the parameter is the change in pressure over the valve. Preferably, the parameter is the relative or percentage change in the pressure over the valve. Preferably, the valve is a compressor bypass valve, wherein the compressor bypass valve is configured to bypass an air compressor of the turbocharged prime mover. Preferably, the valve is a throttle valve, wherein the throttle valve is configured to throttle fluid flow to the prime mover. Preferably, the valve is a wastegate valve, wherein the wastegate valve is configured to bypass the turbocharger. Preferably, the valve is an engine bypass valve, wherein the engine bypass valve is configured to control a bypass flow from the engine turbocharger compressor outlet to the turbocharger turbine inlet.

Preferably, the parameter of the power generation system is a parameter of the turbogenerator. Preferably, the parameter of the turbogenerator is the speed of a turbine of the turbogenerator. Preferably, the parameter of the turbogenerator is the electrical power output of the turbogenerator.

Preferably, the step of providing a turbogenerator further comprises a providing power electronics configured to receive the electrical output of the turbogenerator. Preferably, the parameter of the power generation system is a parameter of the power electronics. Preferably, the parameter of the power electronics is the electrical power received by the power electronics from the turbogenerator.

Preferably, the parameter is a temperature or pressure. Preferably, the parameter is the temperature or pressure of a fluid inside the power generator system. Preferably, the parameter is the temperature or pressure of a fluid inside an air inlet of the prime mover. Preferably, the parameter is the temperature or pressure of a fluid inside the air inlet upstream of an air compressor of the turbocharged prime mover. Preferably, the parameter is the temperature or pressure of a fluid inside the air inlet downstream of an air compressor of the turbocharged prime mover. Preferably, the temperature or pressure of a fluid inside the system is upstream of a turbine of the turbocharged prime mover. Preferably, the temperature or pressure of a fluid inside the system is downstream of a turbine of the turbocharged prime mover.

Preferably, the parameter of the power generation system is a measurement of the ambient conditions.

Preferably, the parameter is the concentration of nitrous oxides in an exhaust fluid flow from the turbocharged prime mover. Preferably, the parameter is the concentration of oxygen in an exhaust fluid flow from the turbocharged prime mover.

Preferably, the threshold value of the parameter is an operating limit of the power generation system. Preferably, the operating limit is a maximum limit. Preferably, the operating limit is a minimum limit.

Preferably, the step of comparing a parameter of the power generation system to a threshold value of the parameter is undertaken continuously.

Preferably, the threshold value is predetermined. Preferably, the threshold value is calculated. Preferably, the threshold value is calculated from a plurality of the parameters detailed herein. Preferably, the threshold value is continuously calculated.

Preferably, the step of adjusting the turbogenerator system to vary the backpressure on the turbocharged prime mover to change the parameter such that it becomes closer to the threshold value comprises adjusting the turbogenerator system to make the measured value equal to the threshold value.

Preferably, the method further comprises the step of ceasing adjustment of the turbogenerator system before the parameter becomes equal to the threshold value. More preferably, the method comprises the step of ceasing adjustment of the turbogenerator system before the parameter lies within a hysteresis band surrounding the threshold value.

According to a second aspect of the present claimed disclosure there is provided a power generation system configured to provide the method as described herein.

### DETAILED DESCRIPTION

Embodiments of the present disclosure will now be described by way of example only and with reference to the accompanying drawings.

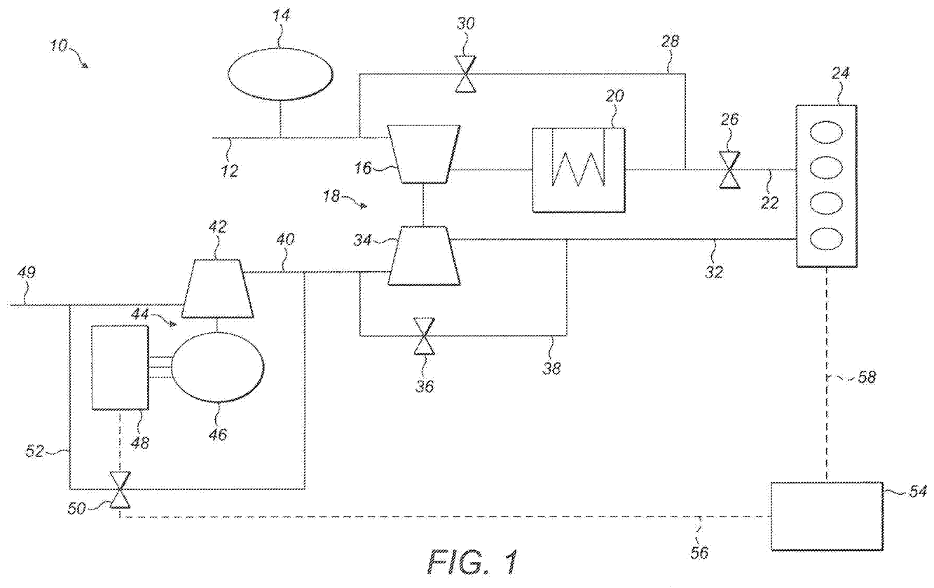

FIG. 1 is a schematic drawing of a power generation system in accordance with a first embodiment of the present disclosure.

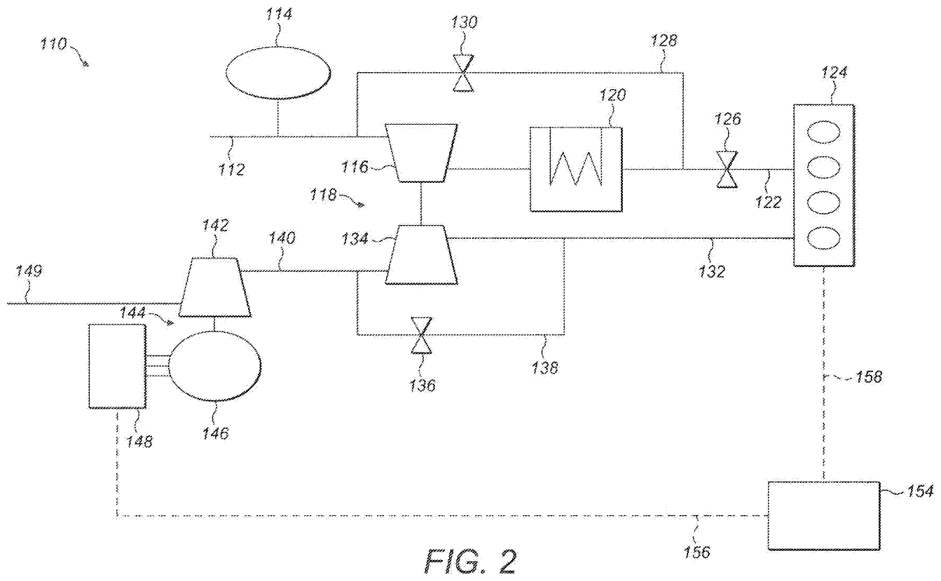

FIG. 2 is a schematic drawing of a power generation system in accordance with a second embodiment of the present disclosure.

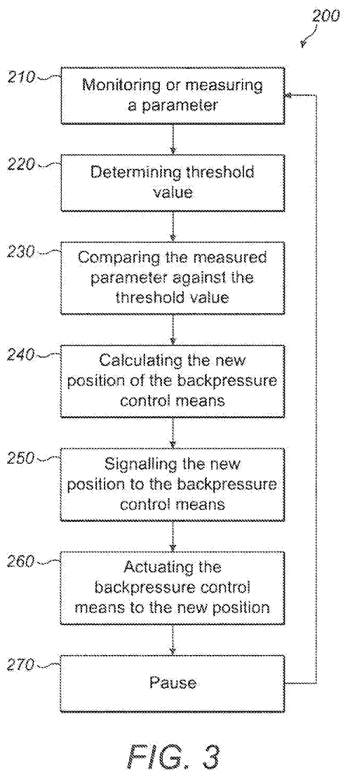

FIG. 3 is a flowchart depicting a method of maximising the total power output of a power generation system.

In the context of this disclosure the skilled addressee would understand that a valve can move from an open position, where its parent conduit is substantially open, to a closed position, where its parent conduit is substantially occluded. When the valve is closed fluid flow through the parent conduit is stopped, whereas when the valve is fully open fluid flow is substantially unimpeded. Furthermore, the valve can be partially opened such that a first portion of the fluid flows through valve, and a second portion of fluid flows is impeded from flowing through the valve.

Referring to FIG. 1 there is depicted a schematic drawing of a power generation system 10 in accordance with the present disclosure.

When the power generation system 10 of FIG. 1 is operational, air enters the power generation system 10 through an air inlet conduit 12 where it is mixed with fuel from the fuel supply 14. The air and fuel mixture is then compressed by the air compressor 16 of the turbocharger 18. During operation, this compression of the air fuel mixture by the compressor 16 results in further air being drawn into the air inlet conduit as is well known in the art.

The compressed air and fuel mixture exits the air compressor 16 and enters the charge air cooler 20 where it is cooled before it enters the gas engine 24 via the engine inlet conduit or intake manifold 22. The cooling action of the charge air cooler 20 improves the fuel efficiency of the gas engine 24. The engine inlet conduit 22 comprises a throttle valve 26. In the described power generation system 10, the position of the throttle valve 26 can be used to control the flow and mass of the air and fuel mixture entering the gas engine 24.

The air compressor 16 and the charge air cooler 20 can be bypassed as the power generation system 10 comprises a compressor bypass conduit 28 and a compressor bypass valve 30. The compressor bypass conduit 28 fluidly connects the air inlet conduit 12 to the engine inlet conduit 22. The compressor bypass valve 30 controls fluid flow through the compressor bypass conduit 28 and through the air compressor 16 and charge air cooler 20.

During operation of the power generation system 10, the gas engine 24 combusts the air and fuel mixture to generate mechanical power, this mechanical power subsequently converted to electrical power.

The waste exhaust gases from the combustion of the air and fuel mixture inside the gas engine 24 are expelled into the engine exhaust conduit 32 as an exhaust fluid. This exhaust fluid flows from the gas engine 24 along the engine exhaust conduit 32 to the turbine 34 of the turbocharger 18. Rotation of the turbine 34 by the flow of exhaust fluid drives the air compressor 16 that compresses air for the gas engine 24. The increased mass of air entering the gas engine 24, as a result of the turbocharger 18 increases the pressure both inside the gas engine 24 and at the intake manifold of the gas engine. This increased pressure can improve the power output and fuel efficiency of the gas engine 24 and is known as the boost pressure. The boost pressure is controlled by the speed of turbine 34 of the turbocharger 18.

Increasing or decreasing the intake manifold 22 pressure can result in undesirable combustion for several reasons, these reasons including engine overheating, pre-ignition or misfiring of the air and fuel mixture within the gas engine 24. Therefore, the intake manifold 22 pressure must be tightly controlled by the inclusion of a throttle valve 26, compressor bypass valve 30 or waste-gate valve 36. Operating these valves varies the reserves available to achieve full load of the prime mover and thus results in a loss in performance under certain operating conditions.

During operation of the power generation system 10, exhaust fluids from the turbine 34 flow from the turbo inlet conduit 40 to drive a turbogenerator 44. Specifically, a turbine 42 of the turbogenerator 44 is rotated by the flow of exhaust fluid, resulting in the concomitant rotation of a rotor within a generator 46 to produce electrical power. The electrical power is transferred to power electronics 48, these power electronics 48 themselves connected to an external electrical grid which consumes the energy recovered from the exhaust fluid flow of the power generation system 10. The exhaust fluid that has passed through the turbogenerator 42 is then expelled to the external environment through the exhaust conduit 49.

The resistance of the turbine 42 of the turbogenerator 44 is primarily due to fluid flow through the nozzle effective area at the inlet to the turbine wheel increasing the pressure, commonly known as backpressure, inside the turbogenerator inlet conduit 40. This increase in pressure impacts the performance of the turbocharger 18, as the pressure differential across the turbine 34 of the turbocharger 18 is reduced. This reduction in the pressure differential causes the turbine 34 of the turbocharger 18 to rotate more slowly, therefore reducing the mass of compressed air and fuel supplied to the gas engine 24 by the air compressor 16.

The backpressure inside the turbogenerator inlet conduit 40 is controlled by the turbogenerator bypass valve 50. The turbogenerator bypass valve 50 controls the flow of exhaust fluid through the turbogenerator bypass conduit 52. In this way, the position of the turbogenerator bypass valve 50 can be used to vary the flow of exhaust fluid to the turbogenerator 44 and the backpressure experienced by the turbocharger 18.

Therefore, the operation of the throttle valve 26, compressor bypass valve 30, waste-gate valve 36 or turbogenerator bypass valve 50 controls both the intake manifold pressure and the reserves available to achieve full load of the prime mover.

The position of the turbogenerator bypass valve 50 is electrically controlled. The signal which determines the position of the turbogenerator bypass valve is provided by an engine controller 54 and communicated to the turbogenerator bypass valve 50 by a first cable 56. The engine controller 54 is connected to the gas engine 24 by a second cable 58, such that the engine controller 54 receives information regarding the control parameter of the gas engine 24. In view of this information, the engine controller 54 then calculates the desired position of the turbogenerator bypass valve 50. The aforementioned calculation is undertaken by comparing the control parameter of the gas engine 24 to a predetermined threshold value for the control parameter of the gas engine 24.

Once the above mentioned comparison has been completed, if the measured value of the control parameter is not equal to the threshold value, the engine controller 54 provides a signal which is communicated to the turbogenerator bypass valve 50 by the first cable 54 and results in the movement of the turbogenerator bypass valve 50 to a new position to vary the backpressure on the turbocharger 18 to change the control parameter of the gas engine 24 to become closer to the threshold value, thereby optimising the total power output or electrical efficiency of the power generation system 10.

Referring to FIG. 2 there is depicted a second embodiment of a power generation system 110 in accordance with the present disclosure. In this embodiment, all features of the power generation system 110, including the air inlet conduit 112, the fuel supply 114, the air compressor 116, the turbocharger 118, the charge air cooler 120, the gas engine 124, the throttle valve 126, the compressor bypass conduit 128, the compressor bypass valve 130, the engine exhaust conduit 132, the turbine 134 for turbocharger 118, the waste-gate valve 136, the waste-gate conduit 138, the turbogenerator inlet conduit 140, the generator 146, the power electronics 148, the exhaust conduit 149, the turbogenerator bypass conduit 152, the engine controller 154 and the second cable 158 are all substantially identical in structure and purpose as the equivalent features in the first embodiment.

The following features of the second embodiment are different from the first embodiment: the turbine 142 for the turbogenerator, the turbogenerator 144, the turbogenerator bypass valve and the first cable 156. The first cable 156 of this embodiment links the power electronics 148 to the engine controller 154 directly.

In this embodiment of the disclosure, the turbine 142 of turbogenerator 144 is a variable geometry turbine. Additionally, the turbogenerator bypass valve and conduit present in the embodiment of the disclosure depicted in FIG. 1 is excluded from the system 110.

In this second embodiment of the disclosure, the backpressure experienced by the turbocharger 134 and produced by the turbogenerator 144 is controlled using a method analogous to the method 100 of the first embodiment. However, rather than the position of turbogenerator bypass valve being used to control backpressure, the geometry of the variable geometry turbine 142 turbogenerator 144 is altered to vary the backpressure on the turbocharger 118 to change the measured value to be closer to that of the threshold value and increase the overall power output or fuel efficiency of the power generation system 110.

Referring to FIG. 3 there is depicted a method 200 for maximising the total power output or fuel efficiency of a power generation system in accordance with the present disclosure.

The method 200 for maximising the total power output of a power generation system begins with step 210 which comprises monitoring and measuring a parameter of the power generation system or its surroundings.

In the next method step 220, a threshold value for the parameter is determined. The threshold value can be determined, for example, by recalling a threshold value form a data memory bank, by receiving the threshold value as a signal from a user or system, by calculating the threshold value from a parameter or parameters of the power generation system, or a combination thereof.

Step 230 is undertaken subsequent to step 220, and comprises comparing the measured parameter of step 210 against the threshold value determined in step 220. For example, a processor, such as the one in an engine controller, may compare the measured value of the parameter to the threshold value by calculating the difference or relative difference between the values.

Subsequently in step 240, a new position or configuration for the backpressure control means is then calculated by the processor. The new position can be calculated based on the comparison between the measured parameter value and the threshold value undertaken in step 230. Alternatively, the new position can be calculated based on the comparison between the measured parameter value and the threshold value undertaken in step 230 in combination with a previously determined or known position or configuration of the backpressure control means.

Subsequently, step 250 comprises sending a signal to the backpressure control means from the processor in step 240, where the signal contains information relation to the new position or configuration of the backpressure control means calculated in step 240. Step 260 comprises actuating the backpressure control means to the position or configuration calculated in step 240 in response to the signal from the processor sent in step 250.

After actuation, the method includes a pause as step 270. After the pause of step 270, the method returns to step 210. As such, the method is a cyclic, continuous or looped process of monitoring and adjusting the position of the a backpressure control means in response to a measured parameter of the power generation system.

In relation to the first embodiment of the disclosure described in relation to FIG. 1, the method 200 responds to the comparison between the measured parameter value and the threshold value by adjusting the position of the turbogenerator bypass valve 50 to vary or alter the backpressure on the turbocharger 18 to change the parameter to become closer to the threshold value and therefore increase the total power output or fuel efficiency of the power generation system.

For example, if the measured value is the temperature of the gas engine 24, and the threshold value is the maximum temperature of the gas engine 24, where the measured value lies below the threshold value the method of the present disclosure will adjust the position of the turbogenerator bypass valve 50 to change the backpressure on the turbocharger 18 to concomitantly vary the measured value of the gas engine 24 temperature such that it becomes closer to the threshold value. In practice, this is undertaken by closing the turbogenerator bypass valve 50 and increasing the fluid flow through the turbogenerator 42. This increase in fluid flow through the turbogenerator 44 increases the power generated by the turbogenerator 44 to maximise the overall power generation of the power generation system 10.

In an alternative example, if the measured value is the rotational speed of the turbine 34, and the threshold value is the optimum rotational speed of the turbine 34, where the measured value lies below the threshold value the method of the present disclosure will adjust the position of the turbogenerator bypass valve 50 to change the backpressure on the turbocharger 18 to concomitantly vary the measured value of the rotational speed of the turbine 34 such that it becomes closer to the threshold value. In practice, this is undertaken by opening the turbogenerator bypass valve 50 and decreasing the fluid flow through the turbogenerator 42. This decrease in fluid flow through the turbogenerator 44 decreases the power generated by the turbocharger 44 but increases the efficiency of the turbocharged gas engine 24, such that the reduction in power output from the turbogenerator 44 is balanced by the increase in power generated by the turbocharged gas engine 24. In this way, the fuel efficiency of the power generation system 10 is maximised.

1. A method comprising;
providing a power generation system comprising a turbocharged prime mover and a turbogenerator system driven by a flow of exhaust fluid from the prime mover, the turbogenerator system creating a backpressure on the turbocharged prime mover,
comparing a parameter of the power generation system to a threshold value of the parameter; and
adjusting the turbogenerator system to vary the backpressure on the turbocharged prime mover to change the parameter to become closer to the threshold value and increase the total power output or fuel efficiency of the power generation system.

2. The method of claim 1, wherein providing the power generation system further comprises providing a turbogenerator bypass valve between the turbocharged prime mover and the turbogenerator within the flow of exhaust fluid, the turbogenerator bypass valve able to move between a bypass open position and a bypass closed position to alter the volume of exhaust fluid passing through the turbogenerator, and further wherein the step of adjusting the turbogenerator system to vary the backpressure on the turbocharged prime mover comprises moving the bypass valve between the bypass open position and the bypass closed position.

3. The method of claim 2, wherein moving the bypass valve between the bypass open position and the bypass closed position comprises moving the bypass valve towards the bypass closed position to increase the volume of exhaust fluid passing through the turbogenerator.

4. The method of claim 2, wherein moving the bypass valve between the bypass open position and the bypass closed position comprises moving the bypass valve towards the bypass open position to decrease the volume of exhaust fluid passing through the turbogenerator.

5. The method of claim 1, wherein providing the power generation system further comprises providing a turbogenerator comprising a variable geometry turbine, and further wherein adjusting the turbogenerator system to vary the backpressure on the turbocharged prime mover comprises changing the geometry of the variable geometry turbine.

6. The method of claim 5, wherein changing the geometry of the variable geometry turbine comprises changing the effective aspect ratio or inlet effective flow area of said variable geometry turbine.

7. The method of claim 6, wherein changing the effective aspect ratio of the variable geometry turbine comprises moving a plurality of vanes within the housing of the variable geometry turbine.

8. The method of claim 1, wherein the parameter of the power generation system is a parameter of the turbocharged prime mover.

9. The method of claim 1, wherein the parameter of the power generation system is a parameter of said a turbocharger of the turbocharged prime mover.

10. The method of claim 1, wherein the parameter of the power generation system is a parameter of the turbogenerator.

11. The method of claim 1, wherein the parameter is at least one of a temperature or pressure.

12. The method of claim 1, wherein the threshold value of the parameter is an operating limit of the power generation system.

13. The method of claim 12, wherein the operating limit is a maximum limit.

14. The method of claim 12, wherein the operating limit is a minimum limit.

15. The method of claim 1, wherein the step of comparing the parameter of the power generation system to the threshold value of the parameter is undertaken continuously.

16. The method of claim 1, wherein the threshold value is pre-determined.

17. The method of claim 1, wherein the threshold value is continuously calculated.

18. The method of claim 1, wherein adjusting the turbogenerator system to vary the backpressure on the turbocharged prime mover to change the parameter such that it becomes closer to the threshold value comprises adjusting the turbogenerator system to make the measured value equal to the threshold value.

19. The method of claim 1, wherein the method further comprises ceasing adjustment of the turbogenerator system before the parameter becomes equal to the threshold value.

20. A power generation system comprising:
a turbocharged prime mover;
a turbogenerator system driven by a flow of exhaust fluid from the turbocharged prime mover, the turbogenerator system configured to create a backpressure on the turbocharged prime mover; and
an engine controller configured to:
compare a parameter of the power generation system to a threshold value of the parameter; and
adjust the turbogenerator system to vary the backpressure on the turbocharged prime mover to change the parameter to become closer to the threshold value and increase the total power output or fuel efficiency of the power generation system.
